(19) United States
(12) Patent Application Publication
(10) Pub. No.: US 2012/0048923 A1
(43) Pub. Date: Mar. 1, 2012

(54) READING APPARATUS AND CONTROL METHOD

(75) Inventor: Satoshi Wakebe, Tokyo (JP)

(73) Assignee: TOSHIBA TEC KABUSHIKI KAISHA, Tokyo (JP)

(21) Appl. No.: 13/217,856

(22) Filed: Aug. 25, 2011

(30) Foreign Application Priority Data
Sep. 1, 2010 (JP) 2010-196205

(51) Int. Cl. G06K 5/00; G06F 17/30

(52) U.S. Cl. 235/380; 235/375

(57) ABSTRACT

According to one embodiment, a reading apparatus includes: an image capturing section configured to capture an image picked up by an image pickup section; a reading section configured to read, from the captured image, an object set in advance and related to the start of reading processing for a commodity and information related to the commodity; and a mode switching section configured to switch, according to the reading of the object, an operation mode from a first mode related to the reading of the object to a second mode related to the reading processing.

### CROSS-REFERENCE TO RELATED APPLICATIONS

This application is based upon and claims the benefit of priority from the prior Japanese Patent Application No. 2010-196205, filed on Sep. 1, 2010; the entire contents of which are incorporated herein by reference.

### FILED

Embodiments described herein relate generally to a reading apparatus and a control method.

### BACKGROUND

In stores such as a supermarket, commodities affixed with code symbols such as barcodes and two-dimensional codes (e.g., QR codes (registered trademark)) are sold. The code symbols of the commodities are obtained by non-intrinsically and latently symbolizing, on the basis of a fixed rule, codes for specifying the commodities. The code symbols are optically read and decoded by a code reading apparatus such as a barcode scanner.

Some code reading apparatus picks up an image of a commodity or the like with a digital camera such as a CCD (Charge Coupled Device) image sensor, detects a code symbol from the picked-up image, and decodes the code symbol. A store clerk takes out a commodity stored in a shopping basket carried onto a counter table by a customer, holds the commodity over the digital camera of the code reading apparatus to cause the digital camera to optically read a code of the commodity to be purchased by the customer, and registers the code.

However, in the code reading apparatus in the past explained above, since reading of a commodity code by image pickup of the digital camera is always performed, for example, if an image of a code symbol is carelessly picked up, wrong reading could be performed. Since it is necessary to maintain a reading state of a commodity code, if reading of a commodity code is not performed for a long time, electric power is uselessly consumed.

### DESCRIPTION OF THE DRAWINGS

FIG. 1 is a schematic external perspective view of the configuration of a checkout lane system;

FIG. 2 is a block diagram of the configuration of a commodity code reading apparatus;

FIG. 3 is a flowchart for explaining an example of the operation of the commodity code reading apparatus; and

FIG. 4 is a conceptual diagram of an example of a reading area in a reading window.

### DETAILED DESCRIPTION

In general, according to one embodiment, a reading apparatus includes an image capturing section, a reading section, and a mode switching section. The image capturing section captures an image picked up by an image pickup section. The reading section reads, from the captured image, an object set in advance and related to the start of reading processing for a commodity and information related to the commodity. The mode switching section switches, according to the reading of the object, an operation mode from a first mode related to the reading of the object to a second mode related to the reading processing.

In general, according to another embodiment, a control method is a control method for a reading apparatus including: capturing an image picked up by an image pickup section; reading, from the captured image, an object set in advance and related to the start of reading processing for a commodity and information related to the commodity; and switching, according to the reading of the object, an operation mode from a first mode related to the reading of the object to a second mode related to the reading processing.

A reading apparatus and a control method according to an embodiment are explained below with reference to the accompanying drawings using a checkout lane system as an example. The checkout lane system has a configuration including a POS (Point Of Sale) terminal that performs registration and settlement of commodities purchased in one transaction and a commodity code reading apparatus that reads commodity codes and the like affixed to the commodities. The checkout lane system is an example of a store system. This embodiment is an application example to a checkout lane system installed in a store such as a restaurant or a supermarket.

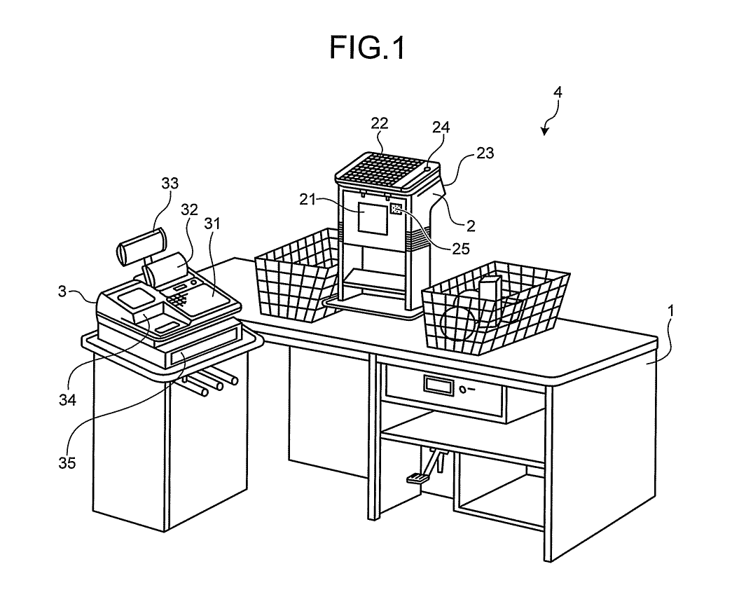

FIG. 1 is a schematic external perspective view of a checkout lane system 4. As shown in FIG. 1, the checkout lane system 4 includes a sucker table 1 for placing a shopping basket including commodities, a commodity code reading apparatus 2 vertically provided substantially in the center of the sucker table 1, and a POS terminal 3 connected to the commodity code reading apparatus 2 to be capable of communicating with each other through a not-shown transmission line.

The POS terminal 3 performs sales registration of commodities purchased by a customer. As shown in FIG. 1, the POS terminal 3 includes a keyboard 31, an operator (store clerk) display 32, a customer display 33, a printer 34 configured to perform receipt printing and the like, and a drawer 35 for storing cash and the like. On the keyboard 31, a closing key and the like necessary for settlement of a commodity price are disposed. The POS terminal 3 includes functions same as those of a standard POS terminal used in a checkout lane system of this type.

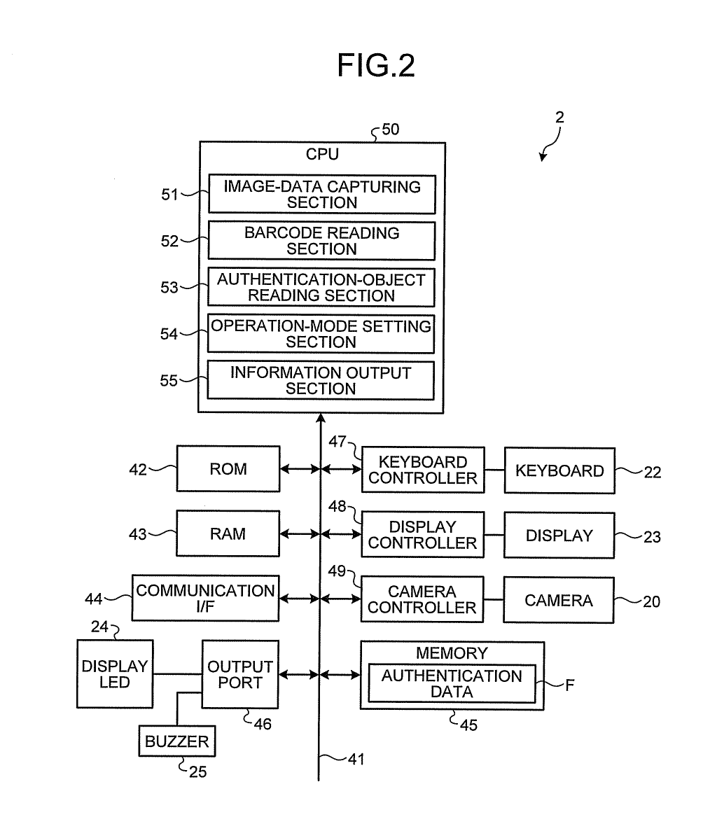

The commodity code reading apparatus 2 is an apparatus for reading a code symbol (hereinafter, barcode) such as a barcode or a two-dimensional code affixed to a commodity when a store clerk holds the commodity over a reading window 21 and outputting commodity information included in the barcode to the POS terminal 3. As shown in FIG. 1, the commodity code reading apparatus 2 mainly includes the reading window 21, a keyboard 22, a display 23, a display LED 24, and a buzzer 25. The keyboard 22 receives operation of various keys by an operator. For example, if registration of a commodity that cannot be registered by a barcode is performed, the keyboard 22 receives an input by the various keys. The display 23 displays a name, a price, and the like of a registered commodity to the customer. The display LED 24 is turned on when the barcode affixed to the commodity is read and informs the operator that the barcode is read. The buzzer 25 emits buzzer sound if the barcode affixed to the commodity is read and informs the operator that the barcode is read. A camera 20 (see FIG. 2) is incorporated on the inside of the commodity code reading apparatus 2 in which the reading window 21 is provided.

FIG. 2 is a block diagram of the configuration of the commodity code reading apparatus 2. The commodity code reading apparatus 2 mainly includes a CPU (Central Processing Unit) 50, a ROM (Read Only Memory) 42, a RAM (Random Access Memory) 43, a communication I/F 44, an output port 46, a keyboard controller 47, a display controller 48, a camera controller 49, and a memory 45. The commodity code reading apparatus 2 is configured by connecting these devices via a bus line 41 such as an address bus or a data bus.

The CPU 50 functions as a control section configured to control the entire operation of the commodity code reading apparatus 2. The ROM 42 has stored therein a computer program according to this embodiment, other computer programs for controlling the operation of the CPU 50, and the like. The CPU 50 has an RTC (Real Time Clock) function for performing time measurement. The RAM 43 functions as a work area when the CPU 50 expands the various computer programs stored by the ROM 42. The RAM 43 stores various data such as image data picked up by the camera 20.

The communication I/F 44 controls data communication with the POS terminal 3 (see FIG. 1) connected via a bus (not shown), an information apparatus such as a store computer (not shown) configured to collectively manage data of the store. The output port 46 outputs driving signals to the buzzer 25 and the display LED 24 under the control by the CPU 50. The keyboard controller 47 captures a key signal from the keyboard 22. The display controller 48 controls data display on the display 23. The camera controller 49 controls an image pickup operation of the camera 20. The camera 20 is a digital camera such as a CCD image sensor or a CMOS image sensor.

The memory 45 is a rewritable nonvolatile memory or the like and has stored therein setting data such as authentication data F. The setting data is obtained by storing data delivered from the POS terminal 3, the store computer, and the like. The authentication data F is data in which an authentication object (details are explained later) related to the start of reading processing of a barcode or the like affixed to a commodity is set in advance. Specifically, the authentication data F may be, for example, information indicating characteristics of the authentication object such as the shape, the size, and the color of the authentication object or image data obtained by picking up an image of the authentication object. If an authentication object is included in an image picked up by the camera 20, the authentication data F may be any data as long as the data enables detection of the authentication object.

A functional configuration of the commodity code reading apparatus 2 realized by the CPU 50 executing a computer program is explained. The CPU 50 operates according to a computer program stored by the ROM 42 and expanded in the RAM 43 to function as, as shown in FIG. 2, an image-data capturing section 51, a barcode reading section 52, an authentication-object reading section 53, an operation-mode setting section 54, and an information output section 55.

The image-data capturing section 51 outputs an image pickup ON signal to the camera controller 49 to cause the camera 20 to start an image pickup operation. The image-data capturing section 51 captures image data (a frame image) picked up by the camera 20 after the start of the image pickup operation and stores the image data in an image work area of the RAM 43.

The barcode reading section 52 performs reading processing for reading information related to a commodity included in the frame image captured by the image-data capturing section 51. Specifically, the barcode reading section 52 detects a barcode included in the frame image captured by the image-data capturing section 51. More specifically, the barcode reading section 52 performs, for example, detection of a barcode by a pattern matching technique from the captured frame image or detection of a two-dimensional code from a predetermined finder pattern. Subsequently, the barcode reading section 52 converts the detected barcode into code information (e.g., a JAN code) conforming to a predetermined rule to read code information corresponding to the detected barcode. Consequently, when an image of a commodity is picked up by the reading window 21, if an image of a barcode affixed to the commodity is picked up, the barcode reading section 52 can read code information corresponding to the barcode (e.g., information related to the commodity such as a commodity code) from a picked-up frame image of the barcode.

The authentication-object reading section 53 reads (detects), from the frame image captured by the image-data capturing section 51, an authentication object set in advance in the authentication data F and related to the start of reading processing performed by the barcode reading section 52. Specifically, the authentication-object reading section 53 reads out information indicating characteristics of the authentication object such as the shape, the size, and the color of the authentication object, an image of the authentication object, and the like set in advance in the authentication data F. Subsequently, the authentication-object reading section 53 detects, using a publicly-known pattern matching technique, an area where the number of similar points based on the information read out from the authentication data F is equal to or larger than a predetermined value in at least a part of an area of the frame image captured by the image-data capturing section 51. The area where the number of similar points is equal to or larger than the predetermined value is equivalent to the area of the authentication object. In other words, the authentication-object reading section 53 detects the authentication object by detecting the area where the number of similar points is equal to or larger than the predetermined value.

The authentication object is an object that the store clerk causes the barcode reading section 52 to read from the reading window 21 in order to start reading processing by the barcode reading section 52. As an example of the authentication object, an object worn only by the store clerk is desirable. The authentication object may be an identification card if the store clerk, a uniform of the store, or the like. Since the authentication object is limited in this way, only the store clerk can start the reading processing by the barcode reading section 52. In the following explanation of this embodiment, as an example, a wristband worn around the wrist of the store clerk is the authentication object. If the authentication object is the wristband, when the store clerk wearing the wristband causes the reading window 21 to read a commodity, reading of the wristband is also performed. Therefore, it is possible to smoothly perform, in a process of causing the reading window 21 to read the commodity, the reading of the authentication object (the wristband) for starting the reading processing.

The operation-mode setting section 54 sets an operation mode of the commodity code reading apparatus 2. Specifically, the operation-mode setting section 54 sets the operation mode to any one of a “standby mode” (a first mode) for the authentication-object reading section 53 to read an authentication object from a frame image captured by the image-data capturing section 51, which is a mode in which the reading processing by the barcode reading section 52 is put on standby, and a “barcode reading mode” (a second mode) in which the barcode reading section 52 performs the reading processing according to the reading of the authentication object.

If the “standby mode” is set by the operation-mode setting section 54, the image-data capturing section 51 sets a period for capturing a frame image picked up by the camera 20 longer than that during the setting of the “barcode reading mode”. If the “standby mode” is set by the operation-mode setting section 54, the camera controller 49 sets the resolution of an image picked up by the camera 20 lower than that during the setting of the “barcode reading mode”. In this way, the period for capturing a frame image is set longer than that during the setting of the “barcode reading mode” and the resolution of an image to be picked up is set lower than that during the setting of the “barcode reading mode”. This makes it possible to reduce electric energy consumed by the commodity code reading apparatus 2 to be smaller than that during the setting of the “barcode reading mode”. During the setting of the “standby mode”, at least one of the condition that the period for capturing a frame image is set longer than that during the setting of the “barcode reading mode” and the condition that the resolution of an image to be picked up is set lower than that during the setting of the “barcode reading mode” only has to be satisfied.

The information output section 55 outputs the code information such as the commodity code read by the barcode reading section 52 to the POS terminal 3 via the communication I/F 44 as reading information. Consequently, the POS terminal 3 specifies, on the basis of the code information such as the commodity code read by the commodity code reading apparatus 2, the commodity read by the commodity code reading apparatus 2 referring to commodity master information in which a commodity name, a commodity classification, a unit price, and the like are set for each commodity code. Subsequently, the POS terminal 3 determines the specified commodity as a commodity to be purchased by the customer and performs sales registration, settlement, and the like of the commodity.

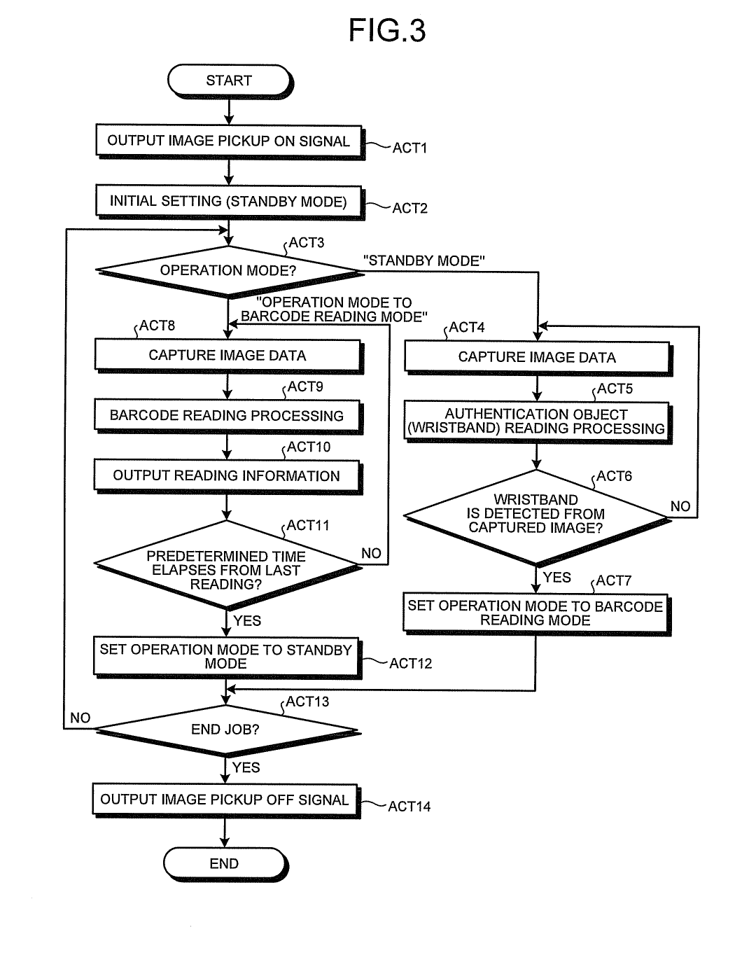

The operation of the commodity code reading apparatus 2 is explained in detail. FIG. 3 is a flowchart for explaining an example of the operation of the commodity code reading apparatus 2.

As shown in FIG. 3, if processing is started, the image-data capturing section 51 outputs an image pickup ON signal to the camera controller 49 and starts image pickup by the camera 20 (Act 1). Subsequently, as initial setting, the operation-mode setting section 54 sets the operation mode of the commodity code reading apparatus 2 to the “standby mode” (Act 2). The CPU 50 advances the processing to Act 3.

In Act 3, the CPU 50 determines whether a currently-set operation mode is the “standby mode” or the “barcode reading mode”. If the currently-set operation mode is the “standby mode”, the CPU 50 advances the processing to Act 4. If the currently-set operation mode is the “barcode reading mode”, the CPU 50 advances the processing to Act 8. In other words, the reading processing (barcode reading processing) by the barcode reading section 52 is started.

In Act 4, the image-data capturing section 51 captures a frame image picked up by the camera 20 and stores the frame image in the image work area of the RAM 43. Subsequently, the authentication-object reading section 53 performs reading processing for reading an authentication object (a wristband) from the frame image captured by the image-data capturing section 51 (Act 5). The CPU 50 determines whether the wristband is detected from the frame image, which is captured by the image-data capturing section 51, according to the reading by the authentication-object reading section 53 (Act 6). If the wristband is not detected (No in Act 6), the CPU 50 returns the processing to Act 4.

If the wristband is detected (Yes in Act 6), the operation-mode setting section 54 sets the operation mode to the “barcode reading mode” (Act 7). The CPU 50 advances the processing to Act 13. In other words, the operation-mode setting section 54 switches the operation mode from the “standby mode” to the “barcode reading mode”.

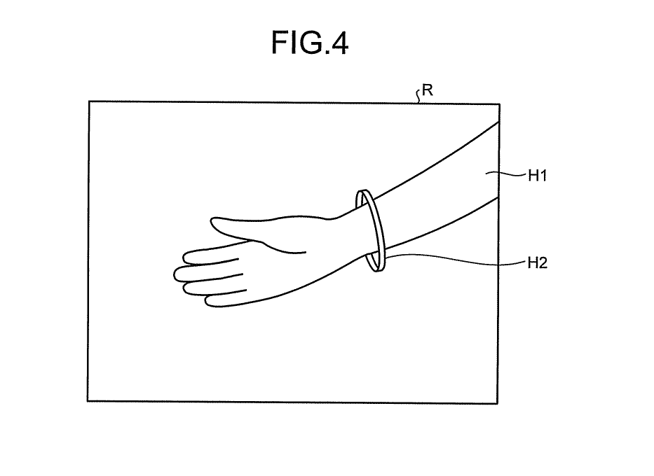

FIG. 4 is a conceptual diagram of an example of a reading area R in the reading window 21. As shown in FIG. 4, if image pickup by the camera 20 is performed in a state in which an arm H1 of the store clerk wearing a wristband H2 enters the reading area R, the wristband H2 is detected from a picked-up frame image. The operation mode is switched from the “standby mode” to the “barcode reading mode” according to the detection of the wristband H2.

In Act 8, the image-data capturing section 51 captures the frame image picked up by the camera 20 and stores the frame image in the image work area of the RAM 43. Subsequently, the barcode reading section 52 performs barcode reading processing for reading information (code information) related to a commodity included in the frame image captured by the image-data capturing section 51. The information output section 55 outputs the code information read by the barcode reading section 52 to the POS terminal 3 via the communication I/F 44 as reading information (Act 10). The CPU 50 advances the processing to Act 11.

In Act 11, the CPU 50 determines whether a predetermined time set in advance elapses from the last reading of code information by the barcode reading section 52. If the predetermined time does not elapse (No in Act 11), the CPU 50 returns the processing to Act 8 and continues the code reading processing by the barcode reading section 52. Time required for the determination in Act 11 is set in advance in the memory 45 or the like and may be changed as appropriate according to an operation form of the store.

If the predetermined time elapses (Yes in Act 11), the operation-mode setting section 54 sets the operation mode to the “standby mode” (Act 12). The CPU 50 advances the processing to Act 13. Specifically, if the predetermined time elapses from the last reading of the code information by the barcode reading section 52, the operation-mode setting section 54 switches the operation mode from the “barcode reading mode” to the “standby mode”. Since the processing shifts to the processing related to the “standby mode” (Acts 4 to 7) according to the switching of the operation mode, the barcode reading processing by the barcode reading section 52 ends. Therefore, if the predetermined time elapses from the last reading of the code information, it is possible to switch the operation mode to the “standby mode” and reduce power consumption.

In Act 13, the CPU 50 determines whether a job is ended according to, for example, notification of the end of commodity registration from the POS terminal 3. If the job is continued (No in Act 13), the CPU 50 returns the processing to Act 3 and continues the processing. If the job is ended (Yes in Act 13), the CPU 50 outputs an image pickup OFF signal to the camera controller 49 and ends the image pickup by the camera 20 (Act 14) and ends the processing.

As explained above, the commodity code reading apparatus 2 includes the image-data capturing section 51, the barcode reading section 52, the authentication-object reading section 53, and the operation-mode setting section 54. The image-data capturing section 51 captures an image picked up by the camera 20. The authentication-object reading section 53 reads an authentication object set in advance and related to the start of reading processing for a commodity from the captured image. The operation-mode setting section 54 switches, according to the reading of the authentication object, the operation mode from the first mode related to the reading of the authentication object to the second mode related to the reading processing for the commodity. The barcode reading section 52 reads information related to the commodity included in the captured image according to the switching of the operation mode to the second mode. Therefore, the commodity code reading apparatus 2 causes the authentication-object reading section 53 to read the authentication object according to necessity to make it possible to realize a reading state of the commodity.

The computer program executed in the commodity code reading apparatus 2 according to this embodiment is provided while being incorporated in a ROM or the like in advance. The computer program executed in the commodity code reading apparatus 2 according to this embodiment may be provided while being recorded in a computer-readable recording medium such as a CD-ROM (Compact Disc Read Only Memory), a flexible disk (FD), a CD-R (Compact Disc Recordable), or a DVD (Digital Versatile Disk) as a file of an installable format or an executable format.

The computer program executed in the commodity code reading apparatus 2 according to this embodiment may be provided while being stored on a computer connected to a network such as the Internet and downloaded through the network. The computer program executed in the commodity code reading apparatus 2 according to this embodiment may be provided or distributed through the network such as the Internet.

The computer program executed in the commodity code reading apparatus 2 according to this embodiment has a module configuration including the sections explained above (the image-data capturing section 51, the barcode reading section 52, the authentication-object reading section 53, the operation-mode setting section 54, and the information output section 55). As actual hardware, a CPU (a processor) reads out the computer program from the ROM and executes the computer program, whereby the sections are loaded onto a main storage and the image-data capturing section 51, the barcode reading section 52, the authentication-object reading section 53, the operation-mode setting section 54, and the information output section 55 are generated on the main storages.

Further effects and modifications can be easily derived by those skilled in the art. Therefore, a wider form of the present invention is not limited to the specific details and the representative embodiment represented and described above. Therefore, various changes are possible without departing from the spirit and the scope of the general concept of the invention defined by the appended claims and equivalents of the claims.

What is claimed is:

1. A reading apparatus comprising:
an image capturing section configured to capture an image picked up by an image pickup section;
a reading section configured to read, from the captured image, an object set in advance and related to start of reading processing for a commodity and information related to the commodity; and
a mode switching section configured to switch, according to the reading of the object, an operation mode from a first mode related to the reading of the object to a second mode related to the reading processing.

2. The apparatus according to claim 1, wherein
the mode switching section switches the operation mode to the first mode if a predetermined time elapses from last reading of the information related to the commodity during the second mode, and
the reading section ends the reading of the information related to the commodity according to the switching of the operation mode to the first mode.

3. The apparatus according to claim 1, wherein, in the first mode, a period for capturing the picked-up image is set longer than that in the second mode.

4. The apparatus according to claim 1, wherein, in the first mode, resolution of the image picked up by the image pickup section is set lower than that in the second mode.

5. The apparatus according to claim 1, wherein
the object is an object worn by a store clerk, and
the reading section detects an area similar to information indicating a characteristic of the object set in advance in the captured image and reads the object.

6. A control method for a reading apparatus comprising:
capturing an image picked up by an image pickup section;
reading, from the captured image, an object set in advance and related to start of reading processing for a commodity and information related to the commodity; and
switching, according to the reading of the object, an operation mode from a first mode related to the reading of the object to a second mode related to the reading processing.

7. The method according to claim 6, wherein
the switching an operation mode includes switching the operation mode to the first mode if a predetermined time elapses from last reading of the information related to the commodity during the second mode, and
the reading an object and information includes ending the reading of the information related to the commodity according to the switching of the operation mode to the first mode.

8. The method according to claim 6, wherein, in the first mode, a period for capturing the picked-up image is set longer than that in the second mode.

9. The method according to claim 6, wherein, in the first mode, resolution of the image picked up by the image pickup section is set lower than that in the second mode.

10. The method according to claim 6, wherein
the object is an object worn by a store clerk, and
the reading an object and information includes detecting an area similar to information indicating a characteristic of the object set in advance in the captured image and reading the object.
